(19) United States
(12) Patent Application Publication
(10) Pub. No.: US 2011/0010497 A1
(43) Pub. Date: Jan. 13, 2011

(54) A STORAGE DEVICE RECEIVING COMMANDS AND DATA REGARDLESS OF A HOST

(75) Inventors: Donald Ray Bryant-Rich, Haifa (IL); Itzhak Pomerantz, Kfar Saba (IL); Rahav Yairi, Oranit (IL)

Correspondence Address: TOLER LAW GROUP, 8500 BLUFFSTONE COVE, SUITE A201, AUSTIN, TX, 78759, US

(73) Assignee: SANDISK IL LTD., KFAR SABA (IL)

(21) Appl. No.: 12/500,387

(22) Filed: Jul. 9, 2009

(51) Int. Cl. G06F 12/00

(52) U.S. Cl. 711/115; 711/E12.001

(57) ABSTRACT

A storage device includes an input device for receiving data and commands directly from a user, without the storage device reporting to or notifying of the storage device activities that result from the received data and received commands. The user may visually-code the commands for the storage device, or s/he may transfer the commands to the storage device as voice commands or as vibration-induced commands. A command transferred by the user to the storage device specifies to the storage device a set of one or more digital contents that are (to be) stored in the storage device, and an operation that is to be performed on the set of one or more digital contents. A command may instruct the storage device to irreversibly caption a set of one or more digital photos by using a caption picture or caption data, or to associate a voice tag to these digital photos.

### FIELD OF THE INVENTION

The present invention generally relates to storage devices and more specifically to methods and to a storage card for receiving commands, for example, to caption digital photos, and data (e.g., captioning data) regardless of a host.

### BACKGROUND

Use of non-volatile storage devices has been rapidly increasing over the years because they are portable and they have small physical size and large storage capacity. Storage devices come in a variety of designs. Some storage devices are regarded as “embedded”, meaning that they cannot, and are not intended to be removed by a user from a host device with which they operate. Other storage devices are removable, which means that the user can move them from one host device (e.g., from a digital camera) to another, or replace one storage device with another. The digital content stored in a storage device can originate from a host of the storage device. For example, digital camera captures pictures and translates them into corresponding digital photos. The digital camera then transfers the digital photos to a storage device, with which it operates, for storage.

Storage devices can store hundreds of digital photos and with no handy captioning tool available photographers are likely to forget which photos were taken where. Even though digital cameras allow photographers to add date and time annotations to digital photos, photographers tend to forget were they took the photos because date and time annotations tell when the digital photos were taken, but not where they were taken.

Various methods exist, which allow photographers to add other types of annotations to digital photos. However, adding and manipulating annotations require a lengthy interaction with menus' buttons of the digital cameras, or using a Personal Computer (“PC”) to post process digital photos. Some digital cameras allow their users to add an annotation image to a digital photo. However, the digital photo and the annotation image are stored as separate files and the annotation image is merely displayed on the display device of the digital camera and is not included in, or part of, the image of the digital photo itself. Therefore, when the digital photo is printed, the printout does not include or contain the annotation image associated with it. In addition, if a file of an annotation image is corrupted or lost, the context of the associated digital photo(s) is lost.

Some of the annotation methods that exist today are not easy to use and/or they can be practiced only off-site. For example, if the digital photos were taken in the open air, oftentimes the photographer has to go home and use her/his PC to deal with the annotations (i.e., select, manipulate, and associate annotations to digital photos). The drawbacks described above are problematic, for example, in situations where someone takes digital photos in a business tradeshow, in a crime scene, in an accident scene, etc., because the photographer would have either to spend a lot of time to digitally process the photos, or to risk forgetting where the photos were taken, and in what context they were taken.

There is therefore a need to address the problem with rudimentary and unsatisfactory annotation methodologies.

### SUMMARY

It would, therefore, be beneficial to be able to automatically perform various operations on digital contents stored or to be stored in a storage card, such as irreversibly captioning digital photos, without having to deal with host menus or to send host commands to the storage device. Various embodiments are designed to implement such digital contents management, examples of which are provided herein.

To address the foregoing, user commands, and in some instances also data (e.g., caption data), are transferred to the storage card for managing digital contents regardless of the host; that is, without the user or storage card requesting permission from or reporting the management activities to the host. For example, a command may cause the storage card to selectively caption digital photos. Such captioning is done by the storage card rather than by the host (e.g., digital camera, mobile phone, or PC) with which it operates. In another example, a command may cause the storage card to replay a currently played music file or to replay a currently played video file. In another example, a command may cause the storage card to lock the storage card to hosts or to erase digital contents.

The storage card includes an input device for receiving user (i.e., host-independent) commands (e.g., photographer's captioning commands) for the storage card in one or more ways. The input device may allow the user to directly transfer commands to the storage card by using Radio Frequency (“RF”) waves, and/or acoustically and/or through vibrations.

If the host of the storage card is a digital camera, the picture-taking capability of the digital camera may be utilized to transfer commands, for example captioning commands, to the storage card's input device as visually-coded images. The storage card's input device may also include an acoustical-to-electrical transducer (i.e., microphone) by which commands can be transferred to the storage card as voice commands. The voice input means may also be used to record interpretive messages (i.e., voice tags). The storage card's input device may also include a mechanical-to-electrical transducer (e.g., piezoelectric sensor) by which commands can be transferred to the storage card by using; e.g., a series of knocks or modulated vibrations.

Responsive to receiving a command (regardless of which methodology is used to receive the command), the storage card performs an operation on one or more digital contents. For example, if the host is a digital camera and the command is a captioning command, the storage card prepares a digital photo as a caption picture (i.e., as a picture tag) and selectively embeds the picture tag in a set of one or more digital photos. The set of one or more digital photos is selected by using captioning commands; i.e., the photographer marks digital photos for captioning for the storage card by transferring corresponding captioning commands to the storage card through the input device. A digital photo may be captioned by using a picture indicator. The picture indicator may be a picture tag (i.e., a caption picture), a caption data, a voice tag, or any combination thereof.

### BRIEF DESCRIPTION OF THE DRAWINGS

Various exemplary embodiments are illustrated in the accompanying figures with the intent that these examples not be restrictive. It will be appreciated that for simplicity and clarity of the illustration, elements shown in the figures referenced below are not necessarily drawn to scale. Also, where considered appropriate, reference numerals may be repeated among the figures to indicate like, corresponding or analogous elements. Of the accompanying figures:

FIG. 1 is a block diagram of a storage card according to an example embodiment;

FIG. 2 is a general method for operating a storage card according to an example embodiment;

FIG. 3 is a private case of FIG. 2, where the command is a captioning command;

FIG. 4 is a method for captioning digital photos according to an example embodiment;

FIG. 5 is a typical timeline of captured digital photos according to an example embodiment;

FIGS. 6A through 6D illustrate various steps in captioning a digital photo according to an example embodiment;

FIGS. 7A and 7B show a method for creating visually-coded commands for a storage card according to an example embodiment;

FIGS. 8A through 8J show a method for creating visually-coded commands for a storage card according to another example embodiment;

FIG. 9 is a simplified method for transferring commands to a storage card according to an example embodiment;

FIG. 10 is a method for identifying commands by a storage card according to an example embodiment;

FIG. 11 is a method for adding a voice tag to a digital photo according to an example embodiment;

FIG. 12 is a block diagram of a storage card according to another example embodiment; and

FIG. 13 schematically shows a method for transferring commands and data to the storage card of FIG. 12.

### DETAILED DESCRIPTION

The description that follows provides various details of exemplary embodiments. However, this description is not intended to limit the scope of the claims but instead to explain various principles of the invention and the manner of practicing it.

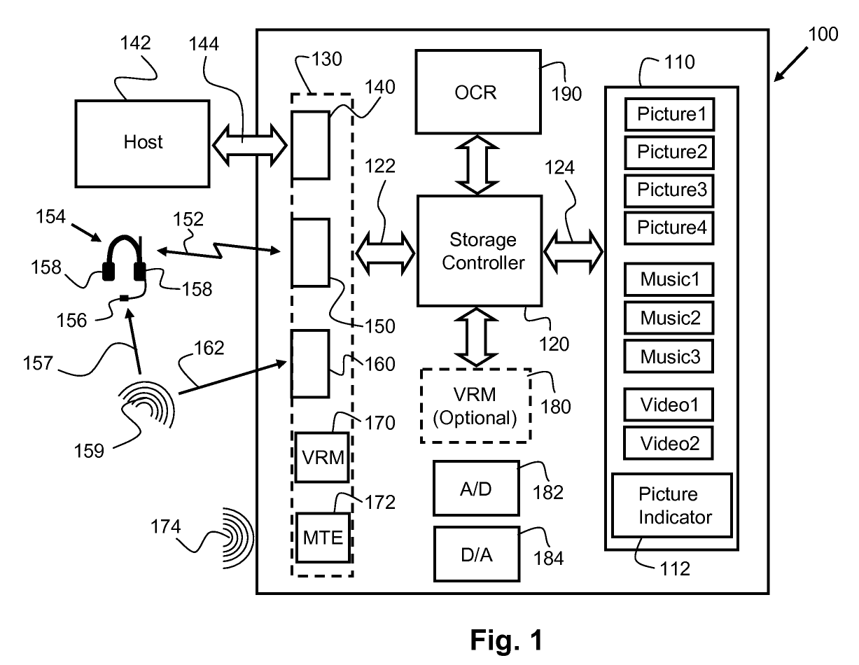

FIG. 1 is a block diagram of a storage card 100 according to an example embodiment. Storage card 100 includes a non-volatile memory (“NVM”) 110, a storage controller 120 for managing NVM 110, and an input device 130. Input device 130 is operative to receive an input signal 122 from a host of the storage device (e.g., host 142) and from a separate signal source unassociated with the host (e.g., wireless headset 154, voice/sound source 159, vibrations source 174), regarding selective use or modification of digital contents stored or to be stored in NVM 110. Input signal 122 may represent digital content, commands, and informative or interpretive data associated with the digital content or commands.

Depending on the type of host 142 (e.g., digital camera, mobile phone; e.g., cellular phone, recording device; e.g., MP3 player, MP4 player, or video camera, etc.) or on the type of an application running on host 142, digital content represented by input signal 122 may be a digital photo, a music file, a video file, a multimedia file, etc. NVM 110 is consisted of, or includes, non-volatile memory cells that may be, for example, flash memory cells.

Input device 130 may include various types of Input/Output (“I/O”) means for transferring various types of input signal 122 to storage card 100. Input signal 122, which is transferred from input device 130 to storage controller 120, may include information and/or commands regarding management (e.g., storage, replay, etc.) of digital contents on NVM 110.

Digital contents and information/commands pertaining to management thereof may be transferred from the user (via input device 130) to storage controller 120 during one or more direct communication sessions between a user and storage card 100. That is, input device 130 receives, and storage card 100 processes and handles, input signal 122 autonomously, without storage card 100 (i.e., input device 130 and storage controller 120) requesting the input signal from host 142 or reporting to or notifying host 142 of activities performed internally (i.e., within storage card 100) consequent to receiving such signals.

Input device 130 may include a host interface, such as host interface 140, to facilitate, for example transfer of digital photos from host 142 to storage controller 120. Input device 130 may also include a wireless interface, such as wireless interface 150, by which a user transfers wireless signals (i.e., electromagnetic signals), which represent data (e.g., data to be used as captioning data) and/or commands (e.g., captioning commands), to storage controller 120. The wireless signals may be modulated, for example, by voice commands. Wireless interface 150 may be or include a Radio Frequency (“RF”) transceiver such as a Bluetooth transceiver. Data and/or commands may be transmitted to and received by wireless interface 150 as Frequency-Shift Keying (“FSK”) signals. Briefly, “FSK” is a frequency modulation scheme in which digital information, which is a combination of digital values “1”s and “0”s, is transmitted using discrete frequency changes of a carrier wave. The simplest FSK is binary FSK (“BFSK”), in which case one frequency is used to transmit binary values “0”s, and another frequency is used to transmit binary values “1”s. A photographer and storage controller 120 may exchange voice messages by using a wireless headset, such as wireless headset 154, and wireless interface 150.

Wireless interface 150 allows storage controller 120 to wirelessly communicate with wireless headset 154 over wireless communication link 152. Communication between storage controller 120 and wireless headset 154 may include transferring 157 voice commands 159 to storage controller 120 through microphone 156 of wireless headset 154 and, optionally, transferring (e.g., as feedback) audible messages from storage controller 120 to earphones 158. A flash memory card known as the “Eye-Fi” card uses Wi-Fi communications, which is based on the IEEE 802.11 standards. The Eye-Fi card incorporates an 802.11 wireless interface into the standard SD card form factor 32 mm×24 mm×2.1 mm. Such a communication technology may be used to facilitate communication between storage controller 120 and wireless headset 154.

Input device 130 may include a built-in acoustical-to-electrical transducer 160 (e.g., microphone) for receiving 162 various data and commands (e.g., captioning commands) for storage controller 120 audibly, for example in the form of voice command or non-vocal recognizable sound 159. Regarding non-voice recognizable sounds, the user may transfer commands 159 to storage controller 120, for example, by whistling a tune. Typically, when photographs are taken, the user holds the digital camera close to her/his head in order to align the camera's viewfinder with the desired field-of-view. Therefore, microphone 160 can (and it is preferable that it) be only sensitive enough to record voices/sounds from a relatively short distance (e.g., a few centimeters away). It is preferable that microphone 160 be unidirectional in order to ensure that it is sensitive to sounds originating from only one source, may it be the user outputting voice commands or a loudspeaker outputting an Audio Frequency-Shift Keying (“AFSK”). Briefly, “AFSK” is a modulation scheme by which digital data is represented by changes in the frequency of an audio tone. Normally, the transmitted audio alternates between two tones: one tone represents a binary one (“1”) and the other tone represents a binary zero (“0”). AFSK allows an encoded signal to be transferred via radio or telephone, and it can be used, mutatis mutandis, to transfer user data and user commands to storage controller 120, for example via wireless interface 150 or microphone 160. U.S. Patent application number 2007/0065968 discloses a miniature microphone made of silicone, which can be incorporated into storage card 100. “TRANSDUCERS USA” sells ultra-thin surface-mount microphones that use an acoustic transducer built with MEMS (“Micro Electrical-Mechanical Systems”) technology combined with a CMOS amplifier to achieve its small size. Being suited for miniaturized, portable electronic equipment application in which high-temperature construction and tiny size are required, such microphones (e.g., the TRMO-4713 series microphones) can be embedded in storage devices such as storage card 100. Typical size of a surface-mount microphone is 4.72 mm×3.30 mm×1.25 mm.

Input device 130 may include a voice/sound recognition module (“VRM”) 170 for processing voice and sound signals that are communicated to storage card 100 via wireless interface 150 and microphone 160. VRM 170 may detect voice commands of the user of digital camera 142, or sound commands, and transfer input signal 122 to storage controller 120 that represents the voice commands. The voice recognition module (VRM) may be incorporated into input device 130 (i.e., VRM 170), or, alternatively, it can be external to input device 130 (i.e., VRM 180). VRM 170 may include an FSK/AFSK module for processing FSK signals and AFSK signals that are respectively received via wireless interface 150 and acoustical-to-electrical transducer 160.

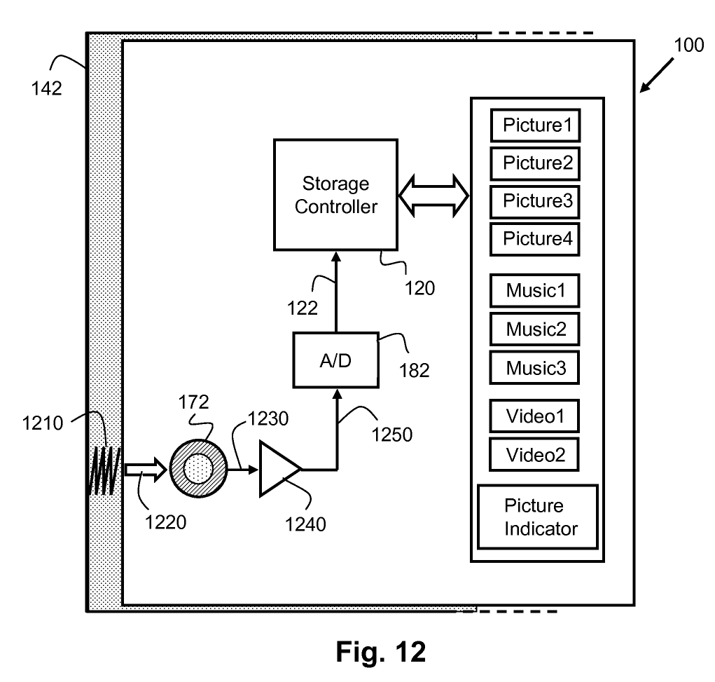

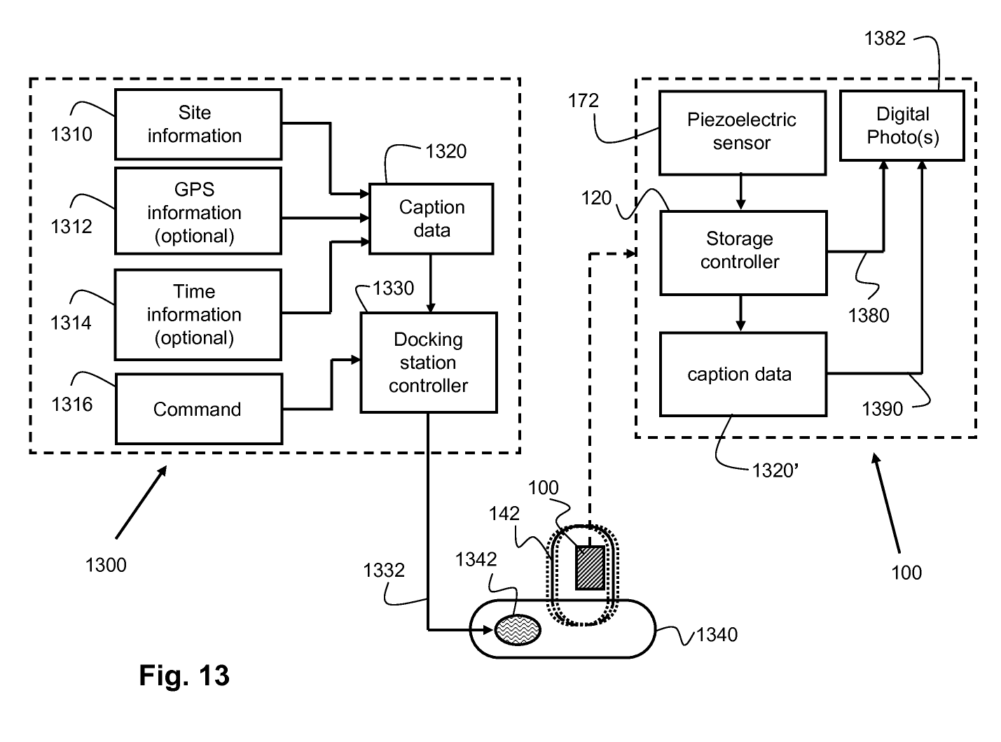

Input device 130 may include a mechanical-to-electrical (“MTE”) transducer 172 for receiving vibration-encoded commands from vibrations source 174. MTE transducer 172 is built into storage card 100 such that when storage card 100 is embedded in or removably connected to host 142, mechanical vibrations of host 142 are transferred to MTE transducer 172. (Note: by vibrating host 142 it functions as vibration source 174.) MTE transducer 172 converts the mechanical vibrations into corresponding electrical input signal 122. By using MTE transducer 172 or similar device, the user of host 142 can transfer vibration-induced commands and vibration-induced data to storage controller 120. The way vibration-induced commands and vibration-induced data are generated and used is shown more fully in FIGS. 12 and 13, which are described below.

Host 142 can be vibrated by the user knocking on it, or by placing host 142 (with storage card 100 connected to it) on a high power loudspeaker and exciting the loudspeaker, for example, by applying to it (e.g., by a PC) FSK signals. Vibration of the high power loudspeaker causes host 142 to vibrate, and the resulting vibrations are mechanically transferred (with somewhat lowered magnitude) to the housing of storage card 100, and thence to MTE 172. MTE 172 may be, for example, a microphone (e.g., model/type ADMP401-1 or ADMP 421 by “Analog Devices”), or a piezoelectric sensor, or a 3-axis accelerometer (e.g., model/type ADXL335 by “Analog Devices”).

Input device 130 is configured to receive input signals as exemplified above, regarding an operation that the user wants to be selectively performed on one or more of the digital contents that are stored, or to be stored, in NVM 110. As part of the response of storage controller 120 to the input signals it receives from input device 130, storage controller 120 manages storage of the one or more digital contents on NVM 110, where the managing includes, inter alia, determining a command from input signal 122 received from input device 130, determining one or more digital contents to which the command pertains, and performing an operation on the determined digital contents based on the determined command.

By way of example, nine digital contents are stored in NVM 110: four digital photos, which are designated as “Picture1”, “Picture2”, “Picture3”, and “Picture4”, three music files, which are designated as “Music1”, “Music2”, and “Music3”, and two video files, which are designated as, “Video1” and “Video2”. Assume that host 142 is a digital camera. After a user of digital camera 142 takes photographs, digital camera 142 sends the resulting digital photos (e.g., “Picture1”, . . . , “Picture4”) to host interface 140 in order for them to be stored in storage card 100. Storage controller 120 receives a corresponding number of input signals 122 that represent the digital photos, and stores 124 the digital photos in NVM 110. Host interface 140 may be used to transfer visually-coded user commands to storage controller 120 regarding, for example, which digital photo should be used as a caption picture, and which digital photos should be captioned using the caption picture as a picture indicator, as described below.

As part of the storage management mentioned above, storage controller 120 defines a picture indicator 112 based on input signal 122, selectively associates picture indicator 122 with a set of one or more digital photos, and stores the set of one or more digital photos on NVM 110 with picture indicator 112 embedded in or associated with each of the one or more digital photos. Referring to the exemplary digital photos stored in NVM 110, the set of one or more digital photos may include, for example, three digital photos (e.g.,“Picture1”, “Picture3”, and “Picture4”); or only two digital photos (e.g., “Picture1” and “Picture3”); or only one digital photo (e.g., “Picture3”), etc.

Picture indicator 112 may be the input (i.e., input signal 122) or a modified version thereof. For example, input signal 122 may be or correspond to a file of a particular digital photo, and picture indicator 112 may be the image of the particular digital photo, meaning that the content of the particular digital photo, serving as a caption tag, may be used to caption the set of digital photos. By “picture indicator” is meant herein a user-initiated interpretive information, image or marking that is embedded in, or associated with, one or more digital photos as a caption tag. A “caption tag” may be a digital image taken through digital camera 142 and transferred 144 to storage controller 120 via input device 130, or an interpretive voice message (i.e., a voice tag) that may be recorded by using either wireless interface 150 or microphone 160. Once a voice tag is recorded, storage controller 120 may associate it with the pertinent digital photo(s). The association between a voice tag and a pertinent digital photo may be done, for example, by using a similar filename. For example, if the file name of the digital photo that was last stored in NVM 110 is, say, “10003jpg”, then the file name of the voice tag pertaining to the digital photo “10003 jpg” may be “10003.mp3”.

Regarding voice tags, storage controller 120 is configured to receive, via input device 130, a recording command, and to respond to the recording command, for example, by recording voices or sounds sensed by wireless microphone 156 and/or by microphone 160 (i.e., depending on the used configuration); i.e., storing the voices or sounds on NVM 110 as audio files. Storage controller 120 may start a voice/sound recording session immediately or some time after it stores a picture in NVM 110, provided that storage controller 120 timely receives a “start recording” command to start the recording. Storage controller 120 may stop the voice recording when it receives a “stop recording” command to stop the recording, or when only environmental sounds are picked up by the microphone(s), or after a predetermined time period elapses. Storage controller 120 may be configured to receive a voice tag some time before or after it stores the picture in NVM 110.

In general, a picture indicator (e.g., picture indicator 112) indicates, or interprets, the locality where a set of selected digital photos were taken. For example, if a photographer wants to take several digital photos near/around the Eiffel Tower or somewhere else in Paris, the photographer may take a picture of the Eiffel Tower (i.e., as an icon of Paris) and have it embedded, as a picture indicator, in some of the subsequent pictures to remind her/him later that these pictures were taken in Paris. A picture indicator may be, for example, a picture of a city/county/region/country map or a road map on which a word of interest is printed, for example a name of a city (e.g., Paris) or district (e.g., Champagne) visited by the photographer; a sign at the entrance of a site or museum, a name jotted on a piece of paper, a picture or name of a famous tourist attraction, etc.

The picture to be used as a picture indicator (i.e., the captioning picture or “picture tag”) is taken and transferred 144 to storage card 100 in a regular way, like any other picture, without digital camera 142 “knowing” that this picture is going to be used as a picture indicator, or being involved in the preparation of the picture for use as a picture indicator. An image used as a picture indicator may irreversibly caption each of the selected digital photos, so that when a captioned digital photo is printed, the pictorial picture indicator would also appear in the printout.

Storage controller 120 is configured to receive a command or an indication from a user (i.e., via communication links 144, 152, or 162) that a particular digital photo should be used as a captioning picture, and another one or more commands or indications regarding which subsequently taken digital photos should be captioned. The subsequently taken digital photos that should be captioned may be interspersed among the digital photos. Implementing the commands transfer methodology and the digital photo captioning methodology disclosed herein does not require unconventional user-camera interaction or unconventional camera-storage card interaction, nor does it require use of unconventional operation menus. That is, digital camera 142 is unaware of the captioning process executed by and in storage controller 120 and, from the camera's perspective, the digital photo used to caption other digital photos is taken and stored in NVM 110 in a conventional manner like any other picture, for example like the digital photos that are to be captioned. The captioning methodology and the way storage controller 120 executes it are described below. Storage controller 120 may also be configured to respond to a user command by updating the picture indicator or by using a different picture indicator, or to define and store in NVM 110 more than one picture indicator from which a user of digital camera 142 can select one for actual captioning while the others are deselected. The user may select a picture indicator by transferring a corresponding command to storage controller 120 by using any of the techniques described herein.

As explained above, a user may transfer to storage controller 120 commands that are visually coded. In order to decode visually-coded commands, the visual patterns embodying the visually-coded commands have to be detected. Therefore, storage card 100 also includes an Optical Code Recognition (“OCR”) unit 190 for detecting visual patterns in pictures that the user transfers to storage controller 120 through digital camera 142. Visual patterns define commands and storage controller 120 interprets a visual pattern detected in a picture to a corresponding command. An image may be embedded in a digital photo as a caption image by using any known computer graphic application. A relatively simple graphic tool to embed one picture in another is Microsoft “Paint”.

Storage card 100 also includes an Analog-to-Digital (“A/D”) converter 182 to digitize analog signals (e.g., voice commands) in order for them to be processed; e.g., by storage controller 120. Storage card 100 also includes a Digital-to-Analog (“D/A”) converter 184 to facilitate transfer of audible messages from storage controller 120 to earphones 158 of wireless headset 154.

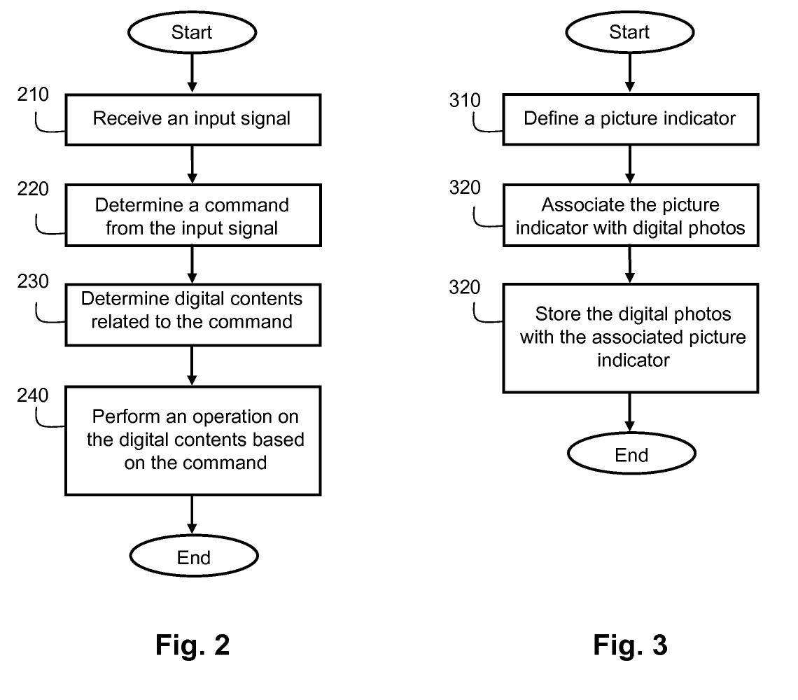

FIG. 2 is a general method for operating storage card 100 of FIG. 1. FIG. 2 will be described in association with FIG. 1. At step 210, storage controller 120 receives an input signal 122 from input device 130. As the input signal may pertain to or be a command or a digital content that is or has to be stored in NVM 110, storage controller 120 has to determine the type of input signal 122. Assume that input signal 122 is a command. Storage controller 120 determines, at step 220, a command from the input signal. At step 230, storage controller 120 determines a set of one or more digital contents to which the command applies. Storage controller 120 may determine the set of one or more digital contents based on metadata or information that are associated with the commands, or based on other commands that are likewise transferred to storage controller 120. At step 240, storage controller 120 performs an operation (or a series of operations) on the set of digital contents based on the command. Selective captioning of one digital photo (e.g., “Picture 3”) or more digital photos (e.g., “Picture1”, “Picture2”, and “Picture4”), replaying a music file (e.g., “Music1”), and replaying a video file (e.g., “Video1”) are exemplary operations.

FIG. 3 is a private case of FIG. 2, where at least some digital contents are digital photos and the command is a captioning command to caption digital photos. FIG. 3 will be described in association with FIG. 1. Managing storage of digital photos by storage controller 120 may include defining, at step 310, a picture indicator; associating, at step 320, the picture indicator with one or more digital photos, and, at step 330, storing the digital photos with the associated picture indicator. Associating a picture indicator with a digital content, or vice versa, may include embedding the picture indicator in the associated digital photo(s). Regarding the playable files that are stored in NVM 110 (i.e., “Music1”, “Music2”, “Music3”, “Video1”, and “Video2”), the command determined at step 220 of FIG. 2 may be a “replay” command, and the operation performed at step 240 of FIG. 2 may include replaying one or more of the playable file, for example according to a default order or play list.

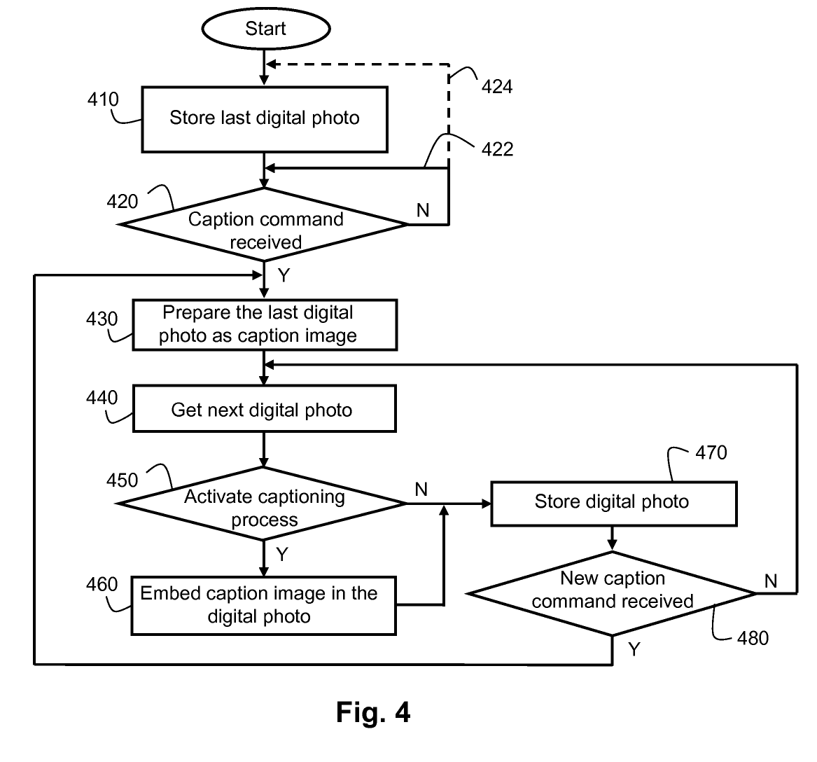

FIG. 4 is a method for captioning digital photos according to an example embodiment. FIG. 4 will be described in association with FIG. 1. At step 410, a user of digital camera 142 takes a picture and storage controller 120 receives 144 the digital photo from digital camera 142 (e.g., “Picture1”) and stores 124 it in NVM 110 like a regular picture. For convenience, each currently taken picture is regarded as the “last digital photo”. At step 420, storage controller 120 checks whether a command (i.e., a captioning command) has been received 122 to use the last digital photo (in this example “Picture1”) as a caption picture. If storage controller 120 does not receive a captioning command (shown as “N” at step 420), storage controller 120 waits for the command (the waiting is shown as loop 422). Receiving a captioning command at this stage would indicate to storage controller 120 that the exemplary digital photo “Picture1” should be used as a caption picture to (selectively) caption subsequent digital photos. While waiting, storage controller 120 may be requested by digital camera 142 to store another digital photo (e.g., “Picture2”) in NVM 110. (Receiving another digital photo while storage controller 120 is waiting for a captioning command is shown as loop 424.) If, after storing “Picture2” in NVM 110, storage controller 120 receives a captioning command, this would indicate to storage controller 120 that “Picture2” (and not the previously taken picture; i.e., “Picture1”) should be used to caption subsequent digital photos.

If storage controller 120 receives a captioning command (shown as “Y” at step 420), storage controller 120 prepares, at step 430, the picture that was stored last in NVM 110 as a caption picture. Preparing a picture as a caption picture includes scaling down the caption picture (i.e., caption tag) so that it would occupy only a small portion (e.g., 5%) of the pictures to be captioned. As most photographers tend to place the main photographic subject in the center of the viewfinder, preparing a picture to serve as a caption tag also includes setting the coordinates of the scaled down picture so that it would appear in a corner of the captioned photo(s), for example in the lower left corner of the captioned photo(s).

If the captioning command is received after “Picture1” is stored in NVM 110 but before “Picture2” is stored there, “Picture1” is used as the captioning image/tag for subsequent pictures. However, if the captioning command is received after “Picture2” is stored in NVM 110 but before another digital photo (e.g., “Picture3”) is stored in NVM 110, digital photo “Picture2” is used as the captioning picture for subsequent pictures, and so on.

At step 440, storage controller 120 receives 144 from digital camera 142 a subsequent digital photo for storage in NVM 110 and, at step 450, it checks whether the captioning process should be activated (i.e., whether subsequent digital photo should be captioned). It is noted that even though storage controller 120 receives a captioning command at step 420, it may receive an additional command from the user of digital camera 142, via input device 130, to activate the captioning process or to inactivate it in order to caption only selected subsequent digital photos (the selection between the two options may be made by the user of camera 142 inputting a corresponding command visually; i.e., through digital camera 142, or audibly; i.e., via wireless microphone 156 or built-in microphone 160).

If the user instructs storage controller 120 to activate the captioning process (shown as “Y” at step 450), then, at step 460, storage controller 120 embeds the caption picture (i.e., a scaled down version of the digital photo associated with the captioning command) in the subsequent digital photo. Then, at step 470, storage controller 120 stores the captioned digital photo (i.e., the subsequent digital photo with the caption picture embedded in it) in NVM 110. If the user instructs storage controller 120 to inactivate the captioning process (shown as “N” at step 450), then, at step 470, storage controller 120 stores the subsequent digital photo in NVM 110 without employing the captioning process; i.e., without embedding a caption picture in the subsequent digital photo.

At step 480, if storage controller 120 does not receive a new captioning command (shown as “N” at step 480), storage controller 120 continues to receive, at step 440, subsequent digital photos from digital camera 142 and either captions them by using the currently used captioning image and repeating steps 450 and 460, etc., or does not caption them (i.e., repeating steps 450 and 470, etc.), as the case may be (i.e., depending on whether the captioning process is active or inactive, which condition is checked at step 450). If storage controller 120 receives a new captioning command (shown as “Y” at step 480), it prepares, at step 430, the digital photo that was most recently received 144 from digital camera 142 as a caption picture and, at step 440, uses it to caption subsequent digital photos that storage controller 120 receives from digital camera 142. Then, steps 450, 460, 470, and 480 may be repeated with respect to each new caption picture and each consequent digital photo.

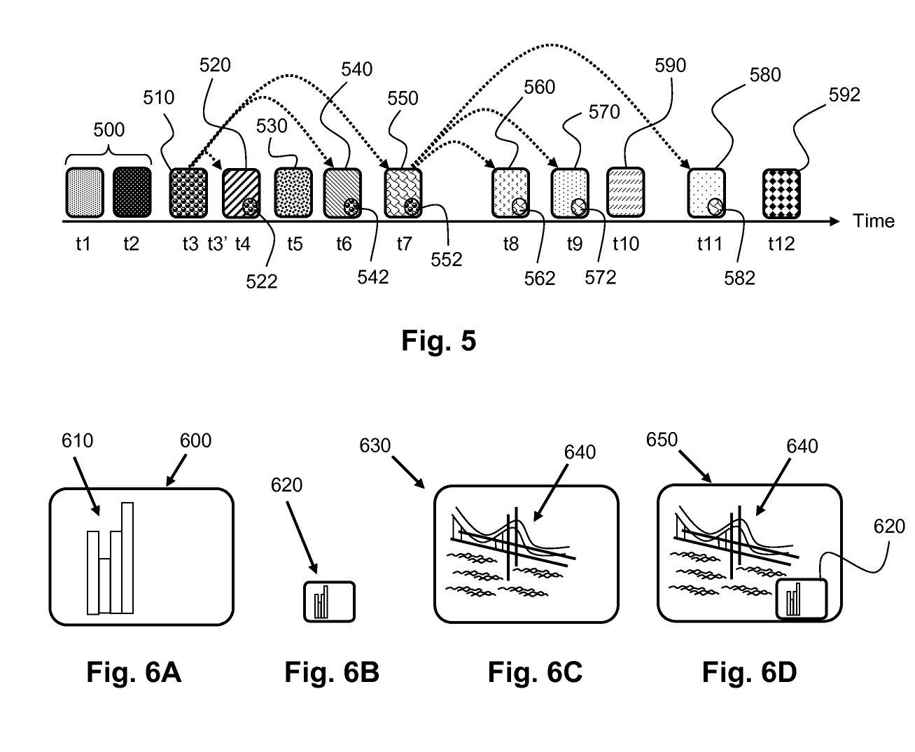

FIG. 5 is a typical timeline of a captioning process according to an example embodiment. FIG. 5 will be described in association with FIG. 1 and FIG. 4. At times t1 and t2, storage controller 120 gets digital photos 500 from digital camera 142. Assuming that storage controller 120 has not received at step 420 any captioning commands yet, it stores digital photos 500 in NVM 110 in a conventional manner; i.e., as is, without embedding a caption picture in them.

At time t3, storage controller 120 receives a digital photo 510 from digital camera 142 for storage in NVM 110. At time t3′ (shortly after digital photo 510 is taken), storage controller 120 receives, at step 420, a captioning command that indicates to storage controller 120 that digital photo 510 should be used as a caption picture to caption subsequent digital photos. As explained above in connection with step 450 of FIG. 4, the captioning process may be activated or inactivated. Assuming it is activated at time t4, or shortly before time t4, storage controller 120 receives the next digital photo (i.e., digital photo 520) from digital camera 142, captions it using digital photo 510, and stores the captioned digital photo 520 in NVM 110. Storage controller 120 captions digital photo 520 with digital photo 510 by down scaling digital photo 510 and embedding the downscaled picture, for example, in the bottom right corner of digital photo 520. For clarity, each digital photo in FIG. 5 has a different background pattern for showing that it has a different photographic content. If a particular digital photo is used as a caption picture, a downscaled version of its background pattern (i.e., its photographic content) appears embedded in subsequent captioned digital photo(s). For example, the downscaled version of digital photo 510, which is used a caption picture, is shown embedded in digital photo 520 at 522.

Assuming the captioning process is inactivated at time t5, storage controller 120 receives the next digital photo (i.e., digital photo 530) from digital camera 142 and stores it in NVM 110 without captioning it. Assuming the captioning process is reactivated at time t6, storage controller 120 receives the next digital photo (i.e., digital photo 540) from digital camera 142, captions it using digital photo 510 (i.e., the last used caption picture/tag), and stores the captioned digital photo 540 in NVM 110. The downscaled version of digital photo 510 is shown embedded in digital photo 540 at 542.

Assuming the captioning process is still active at time t7, storage controller 120 receives the next digital photo (i.e., digital photo 550) from digital camera 142, captions it using digital photo 510, and stores the captioned digital photo 550 in NVM 110. The downscaled version of digital photo 510 is shown embedded in digital photo 550 at 552.

Assumed that storage controller 120 receives a new captioning command some time between time t7 and time t8. As explained above in connection with step 420 of FIG. 4, when storage controller 120 receives a captioning command it prepares the most recently received digital photo as a caption picture and uses it to caption subsequent digital photos. Accordingly, at time t8, storage controller 120 receives digital photo 560 and captions it using digital photo 550 as a caption picture/tag. The downscaled version of the original (i.e., uncaptioned) digital photo 550 is shown embedded in digital photo 560 at 562.

Storage controller 120 continues to use original digital photo 550 to caption subsequent digital photos if the captioning command is still valid (i.e., if it has not been replaced by another captioning command), provided that the captioning process is active, as per step 450 of FIG. 4. For example, at times t9 and t11 the captioning command is still valid and the captioning process is active and, therefore, digital photos 570 and 580 are captioned using original digital photo 550. The downscaled version of digital photo 550 is shown embedded in digital photo 570 at 572, and in digital photo 580 at 582. On the other hand, at times t10 and t12 the captioning command is still valid but the captioning process is inactive and, therefore, digital photos 590 and 592 are not captioned.

Because every captioned digital photo is also a potential caption picture, storage controller 120 stores in NVM 110 an uncaptioned version of the captioned picture. This way, storage controller 120 can use the potential caption picture later to caption subsequent picture(s). If storage controller 120 receives from digital camera 142 an additional digital photo before it receives a new captioning command for the potential caption picture, the last caption command will still be applied to subsequent picture(s). For example, digital photo 550, which is captioned at time t7 by digital photo 510, is a potential caption picture. That is, if storage controller 120 receives a new captioning command at any time between t7 and t8, digital photo 550 becomes replaces digital photo 510 as the caption picture, and if storage controller 120 does not receive a new captioning command, or it receives it later (i.e., after time t8), the captioning command that was received last (i.e., the captioning command pertaining to digital photo 510) would still be valid.

FIGS. 6A, 6B, 6C, and 6D illustrate steps in captioning a digital photo according to an example embodiment. FIG. 6A through FIG. 6D will be described in association with FIG. 1. By way of example, FIG. 6A is a picture 600 of skyscrapers 610 taken, for example, in New-York city. It is assumed that the photographer (i.e., the user of digital camera 142) wants to use picture 600 to caption other pictures to be taken later in New York city, because skyscrapers 610 are famous and, therefore, can remind the photographer that the subsequent pictures were taken in New York city. Picture 600 is, therefore, taken and stored in memory 100 like any other picture.

In order to prepare picture 600 for captioning subsequent pictures, the photographer transfers a captioning command to storage controller 120. As explained above, upon receiving a captioning command, storage controller 120 checks which of the pictures stored in NVM 110 was received 144 last from digital camera 142. In this example, the last picture that was sent from camera 142 is picture 600. Therefore, as part of the captioning process, storage controller 120 down scales picture 600. (The downscaled version of picture 600 is shown in FIG. 6B at 620.)

With reference to FIG. 6C, the photographer takes another picture 630, for example of a bridge 640 on the Hudson River in New-York city. With reference to FIG. 6D, and assuming the captioning process is active, when storage controller 120 receives picture 630 from digital camera 142 it creates a captioned picture 650 in which the caption picture (i.e., the scaled down version 620 of caption picture 600) is affiliated, or embedded, in picture content 640. If the photographer prints captioned picture 650, the printout would include the original content of picture 640 and the embedded caption picture 620. If subsequent pictures are taken by the photographer, the scaled down version 620 of caption picture 600 captions also these pictures, provided that no other picture has been designated as a caption picture and that the captioning process is active.

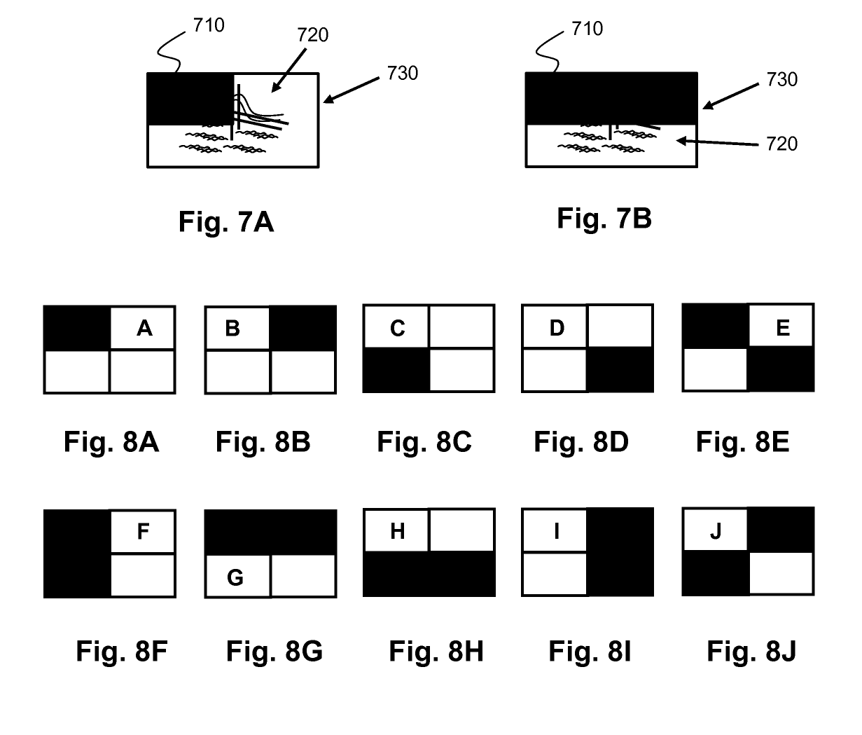

As explained above, storage controller 120 receives commands from a photographer with regard to captioning digital photo, for example. One way to transfer such commands to storage controller 120 is by transferring to storage controller 120 visually coded commands. That is, the photographer may snap shot a visually coded command and storage controller 120 may receive the digital photo thereof from digital camera 142 and decipher the command by using an image processing tool (e.g., OCR 190). Exemplary visually-coded commands are shown in FIGS. 7A and 7B and in FIGS. 8A through 8J, which are described below.

FIGS. 7A and 7B show an optically opaque object 710 for creating visually distinct captioning commands for a storage card according to another example embodiment. FIGS. 7A and 7B will be described in association with FIG. 1. Object 710 is positioned in front of the lens of the camera in a manner to “darken” (i.e., to visually block) one or more quarters of the camera's viewfinder. In FIG. 7A, object 710 blocks the upper left quarter of the camera's viewfinder and in FIG. 7B object blocks the upper half of the camera's viewfinder, thereby generating two distinct coded captioning commands for storage controller 120.

The image 720 captured by digital camera 142 with the coded command can be any image because the picture as a whole (i.e., picture 730) is used only to transfer captioning commands to storage controller 120. Captured image 720 should be bright enough in order to have sufficient contrast that will allow storage controller 120 to correctly decipher the coded command. Storage controller 120 may delete picture 730 shortly after it deciphers the user captioning command because picture 730 has no use other then transferring the captioning command. Object 710 may be, for example, a credit card, a business card, or a photographer's finger.

FIGS. 8A, 8B, 8C, 8D, 8E, 8F, 8G, 8H, 8I, and 8J show various visually coded commands (e.g., captioning commands) according to an example embodiment. FIGS. 8A through 8J will be described in association with FIG. 1, FIG. 7A, and FIG. 7B. Depending on the desired captioning command, which, by way of example, may be any of the visually coded caption commands shown in FIGS. 8A through 8J, the photographer holds object 710 in front of the camera in order to blacken/block the corresponding quarter(s) of the camera's viewfinder. Then, the photographer photographs the image with the blackened/blocked quarter(s), to thereby cause the camera to transfer a corresponding coded command to storage card 100, where the coded command is decoded by storage controller 120.

As shown in FIGS. 8A through 8J, commands are coded using quaternary images/pictures; i.e., each quarter of the camera's viewfinder may be blackened or not. This way, a unique ‘bright-black’ combination (i.e., code) can be created, which represents a specific command. For example, in FIG. 8A only the upper-left quarter of the camera's viewfinder is blackened, whereas the other quarters are not blackened and, therefore, they remain less black (i.e., brighter). The command embodied in FIG. 8A may be, for example, a command for storage controller 120 to use the last picture as a caption picture until storage controller 120 is instructed otherwise; the command embodied in FIG. 8B may be, for example, a command for storage controller 120 to insert a caption picture to the last picture; the command embodied in FIG. 8C may be, for example, a command for storage controller 120 to insert the last picture as a caption picture to all the subsequent pictures; the command embodied in FIG. 8D may be, for example, a command for storage controller 120 to stop inserting caption pictures, and so on. Storage controller 120 may employ an image processing tool, such as OCR 190, to decipher the bright-black combinations in order to identify the captioning commands. Commands may alternatively be transferred to the storage controller 120 as visual data, such as a picture that includes coded strips (i.e., barcodes) or a specific recognizable image/icon. Such an icon may be a relatively simple image (for example, black icon on a white background) such that simple processing/filtering will suffice to differentiate between a normal picture and a possible icon based, for example, on color range alone. The user would need to have available a set of icons to photograph, but, if required (e.g., when the set is lost), these could be printed on a single printable media. Other symbols can be used to transfer visual commands.

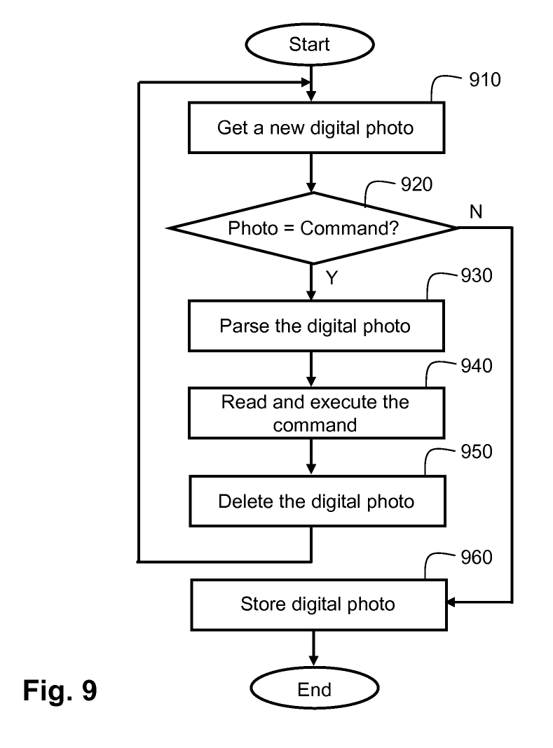

FIG. 9 is a simplified method for transferring visually-coded commands to a storage card according to an example embodiment. FIG. 9 will be described in association with FIG. 1. As explained above in connection with OCR unit 190, a photographer may transfer a captioning command to storage controller 120 in the form of a visually coded picture. This means that storage controller 120 has to decide whether the user transfers to it commands in a visual manner, via host interface 140. More specifically, storage controller 120 has to decide whether a currently taken picture is or includes a command, as explained further below.

At step 910, storage controller 120 receives a new digital photo from digital camera 142. At step 920, storage controller 120 executes a preliminary procedure to check whether the new digital photo is likely to be, or likely to include, a coded command. If commands are coded using quaternary pictures, storage controller 120 may check whether the new digital photo is likely to be, or likely to include, a coded command, for example, by analyzing the brightness level of pixels near, at, or around boundaries that separate between quarters of the digital photo. If, based on the pixel brightness analysis, storage controller 120 decides that there is a significant contrast between at least two quarters, which means that the new digital photo is likely to be, or it is likely to contain, a command (shown as “Y” at step 920), then, at step 930, storage controller 120 pixel-wise parses the digital photo to four quarters, and, at step 940, it detects the blackened quarter(s) and translates (i.e., decode) them into a corresponding command. Also at step 940, storage controller 120 executes the command. By “pixel-wise parses the digital photo to four quarters” is meant that storage controller 120 identifies the pixels of each quarter in order to calculate for each quarter an average brightness or color level. Then, storage controller 120 decides that a quarter is blackened if, for example, the quarter has an average brightness or color level that is lower than a predetermined threshold value, or if its average brightness or color level is conspicuously lower than the average brightness or color level of at least one of its adjacent quarters.

At step 950, after the digital photo containing the coded command is exhausted (i.e., parsed and decoded by storage controller 120), storage controller 120 deletes the digital photo and prepares to receive a new digital photo from digital camera 142. If the command transferred to storage controller 120 is a captioning command, storage controller 120 captions the next digital photo(s) by using the digital photo that was received from the digital camera just before the captioning command. If the new digital photo is not, or it does not contain, a command (shown as “N” at step 920), storage controller 120 may store, at step 960, the digital photo in a conventional way (i.e., uncaptioned).

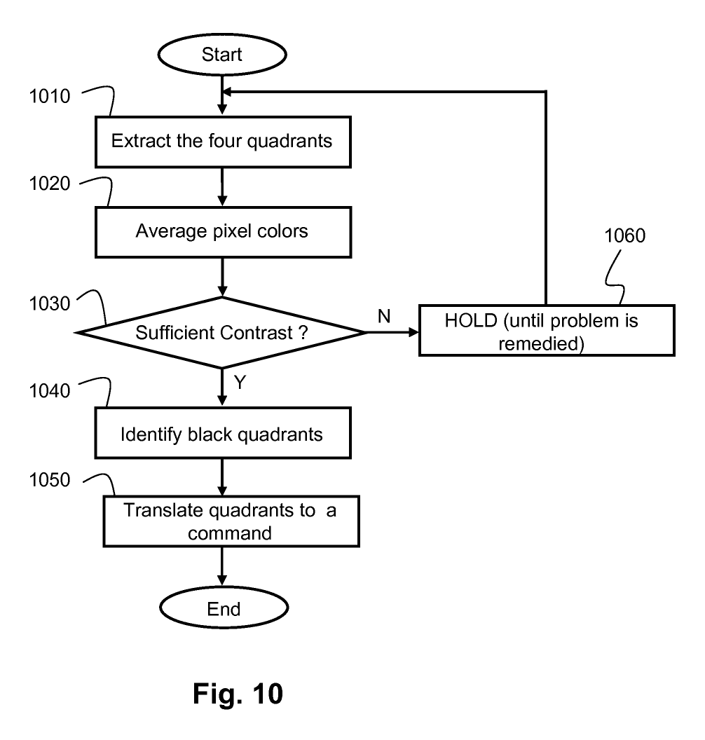

FIG. 10 is a simplified method for reading a coded command by a storage controller such as storage controller 120 according to an example embodiment. FIG. 10 will be described in association with FIG. 1. For convenience, it is assumed that commands are coded using quaternary pictures. At step 1010, storage controller 120 extracts the four quadrants of a digital photo. At step 1020, storage controller 120 calculates an average value for the pixels color. At step 1030, storage controller 120 checks whether there is sufficient contrast between the various quadrants. If there is no sufficient contrast between the quadrants (shown as “N” at step 1030), this means that there is a probability that storage controller 120 would not be able to correctly decode the decoded command. Therefore, at step 1060, storage controller 120 may defer tasks until the problem is resolved, or send to earphones 158 a message regarding the problem. If there is sufficient contrast between the quadrants (shown as “Y” at step 1030), storage controller 120 identifies, at step 1040, the black quadrants in the image and, at step 1050, it translates the bright-black combination into a correspond command.

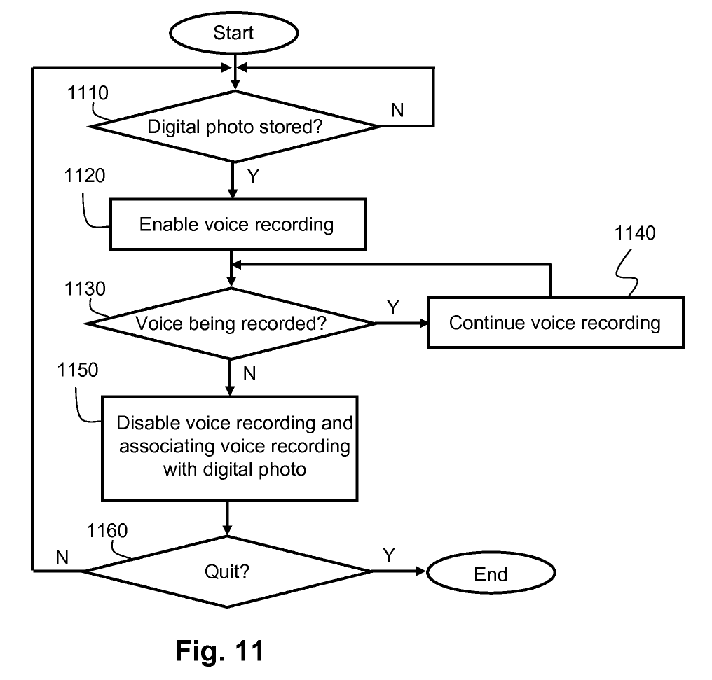

FIG. 11 is a method for transferring voice commands to a storage card according to an example embodiment. As explained above, a picture indicator may be an image tag or a voice tag (i.e., a voice recording that is associated with a particular picture). FIG. 11 will be described in association with FIG. 1. Storage controller 120 may handle voice tags in the way described below.

At step 1110, storage controller 120 checks whether a new digital photo has been stored. If a new digital photo has not been stored (shown as “N” at step 1110), storage controller 120 disables a voice recording process and waits for a new digital photo. While waiting, storage controller 120 is in a non-recording mode of operation. If a new digital photo has been stored (shown as “Y” at step 1110), storage controller 120 enables a voice recording procedure (i.e., it transitions to a recording mode) and, at step 1120, starts recording the user's voice. While the voice recording process is enabled, storage controller 120 checks, at step 1130, whether the currently recorded audio signal includes or contains voice. If the currently recorded audio signal still includes or contains voice; i.e., voice is continued to be recorded (shown as “Y” at step 1130), storage controller 120 continues the recording, at step 1140. If storage controller 120 does not detect voice signals in the recorded audio signals (shown as “N” at step 1130), then, at step 1150, storage controller 120 disables (i.e., concludes) the recording procedure and associates the voice recording with the new digital photo. At step 1160, storage controller 120 checks whether a user command has been received to quit. If no such command has been received (shown as “N” at step 1160), storage controller 120 waits, at step 1110, for a subsequent digital photo and repeats steps 1120 through 1150 with the subsequent digital photo.

FIG. 12 shows a vibration-induced signal flow in storage card 100 according to an example embodiment. FIG. 12 will be described in association with FIG. 1. As stated above in connection with FIG. 1, storage card 100 includes a mechanical-to-electrical transducer (i.e., MTE transducer 172) by which vibration-induced commands and data can be transferred to storage controller 120. Storage card 100 is embedded in or removably connected to host 142 such that the two devices are coupled mechanically.

Host 142 is forced to moderately vibrate in a manner to convey data or commands to storage controller 120. While host 142 vibrates, a vibrations 1210 are mechanically transferred 1220 to MTE transducer 172 via the mechanical coupling, and MTE transducer 172 outputs an electrical signal 1230 correlated to the vibrations. Electrical signal 1230 is input to an amplifier 1240, and the amplifier's output signal 1250 (i.e., an amplified version of signal 1230) is input to A/D 182. A/D 182 digitizes electrical signal 1230 and sends to storage controller 120 an input signal 122 that represents digitized electrical signal 1230. Storage controller 120, then, detects the data or command(s) in input signal 122 and operates accordingly, as described herein.

The user may transfer relatively simple commands to storage controller 120 by knocking host 142 (e.g., by using a finger or some other tool, for example a stylus or a pen). Each knock-induced command is defined by a unique series of mechanical pulses that is generated by a unique series of knocks characterized: (1) by the number of knocks, and (2) by the rhythm of the knocks. That is, commands to be transferred to storage controller 120 are differentiated by using different numbers of knocks, and/or by using the same number of knocks but with different rhythms, or by using different numbers of knocks and different rhythms.

The unique series of mechanical pulses is sensed by MTE transducer 172 and storage controller 120 interprets it to the corresponding command. “Use the last digital photo as a caption picture”, “Start captioning the subsequent digital photos”, “Stop captioning digital photos”, “Temporarily pause playback”, “Resume play back”, and “Replay the currently played digital content” are examples for simple knock-induced commands. By way of example, the user may transfer the command “Start captioning the subsequent digital photos”, “Stop captioning digital photos” to storage controller 120 by knocking host 142 seven times using a first rhythm, and the command “Stop captioning digital photos” by knocking host 142 seven times using a second rhythm, or five times using a third rhythm, etc.

In general, MTE transducer 172 allows the user to transfer to storage card 100 various types of commands and codes. For example, the user may instruct storage controller 120 to lock storage card 100 (i.e., to deny access from any host) or to erase selected data from the memory by “knocking in” a corresponding password. In another example, MTE transducer 172 allows the user to transfer commands to storage card 100 using Morse code.

In another example, if a song is stored in storage card 100, which has a given rhythm, MTE transducer 172 allows the user to knock on the host a series of knocks at that rhythm. Then, storage controller 120 may detect the rhythm and find the song associated with that rhythm. Then, upon a next interaction between host 142 and storage controller 120, storage controller 120 may forward to the user a message that it has found in NVM memory 110 a song whose rhythm matches the rhythm “knocked in” by the user. Commands similar to the commands mentioned above and more complex commands may be transferred to storage controller 120 by using an electromechanical vibrator, as shown in FIG. 13, which is described below.

In a case where MTE transducer 172 is or includes a 3-axis accelerometer, commands can be transferred to storage controller 120 as user gestures. Gestures are 4-dimensional; namely, they can be generated using axes X, Y and Z, and time, as opposed to using knocks that are 2-dimensional because they are generated using one axis and time. Therefore, gestures provide a full range of motion so they can match intuitive motions. For example, the user of a digital camera may make an “erase” gesture by turning the camera over and shaking it (as if emptying a container). Likewise, the user may shake the digital camera to the right repeatedly to move a picture or to move the next picture, etc.

FIG. 13 is a method for transferring commands to storage card 100 of FIG. 1 according to an example embodiment. A site device 1300, which belongs to a site owner or operated by a site manager, provides information, for example, to a tourist, to a hotel guest, to a traveler, etc. about a site of interest. A “site of interest” may be, for example, a museum, Rockefeller Center, a public library, a cathedral, a parliament toured by many tourists, an airport, a book store, etc. Such information, or a derivative thereof, may be used as caption data, and storage controller 120 may selectively caption digital photos by using caption data rather than caption picture (i.e., the picture indicator can be caption data). The information provided by site device is referred to hereinafter as “site information 1310”. Site device 1300 may also provide Global Positioning System (“GPS”) information 1312 and time information 1314 that are respectively related to the site's location and to the date/time at which information 1310 was provided to the information requester. GPS information 1312 and time information 1314 are optional. Site device 1300 is configured to provide the (site) information to the tourist/hotel guest/traveler by moderately vibrating her/his host (e.g., cellular phone or digital camera). For example, in order to transfer (site) information to host 142 the user places host 142 in a Vibratory Docking Station (“VDS”) 1340 that is connected to Site device 1300 by electric wires.

The user may operate site device 1300 (the site controller is not shown in FIG. 13) to compile caption data 1320 by selecting information from site information 1310, GPS information 1312, and time information 1314. After caption data 1320 is fully compiled, it is transferred to docking station controller 1330 which converts caption data 1320 to a corresponding electrical signal 1332. Docking station controller 1330 then sends electrical signal 1332 to an electromechanical vibrator 1342, which is part of VDS 1340, to cause VDS 1340 to vibrate. In other words, the site controller uses electromechanical vibrator 1342 to convert caption data 1320 to a corresponding series of mechanical vibrations. The mechanical vibrations are transferred to storage card 100 and converted in storage card 100 to caption data 1320 in a reverse process, as described below. Docking station 1340 vibrates host 142, and host 142 vibrates storage card 100. MTE transducer 172 in storage card 100 senses the vibrations and outputs a corresponding electrical signal from which storage controller 120 extracts the caption data 1320. The extracted caption data is shown as caption data 1320′. Docking station controller 1330 transfers also command 1316 to storage card 100 in the same way as caption data 1320. Namely, docking station controller 1330 converts command 1316 to vibrations and storage controller 120 uses MTE transducer 172 to “sense” the vibration-induced command. Storage controller 120 then selects 1380 digital photo(s) 1382 to which the commands pertains, and associates 1390 caption data 1320′ to the selected digital photo(s) 1382; e.g., embeds caption data 1320′ in the selected digital photo(s). Site device 1300 may be located, for example, in a tourist information center. Site device 1300 may be an in-situ device. For example, if site device 1300 provides information about the Eiffel Tower in Paris, it can be located at the locality (e.g., entrance) of the Eiffel Tower.

The articles “a” and “an” are used herein to refer to one or to more than one (i.e., to at least one) of the grammatical object of the article, depending on the context. By way of example, depending on the context, “an element” can mean one element or more than one element. The term “including” is used herein to mean, and is used interchangeably with, the phrase “including but not limited to”. The terms “or” and “and” are used herein to mean, and are used interchangeably with, the term “and/or,” unless context clearly indicates otherwise. The term “such as” is used herein to mean, and is used interchangeably, with the phrase “such as but not limited to”.

Having thus described exemplary embodiments of the invention, it will be apparent to those skilled in the art that modifications of the disclosed embodiments will be within the scope of the invention. Alternative embodiments may, accordingly, include more modules, fewer modules and/or functionally equivalent modules. The present disclosure is relevant to various types of embedded and removably connectable mass storage devices such as SD-driven flash memory cards, flash storage devices, non-flash storage devices, “Disk-on-Key” devices that are provided with a Universal Serial Bus (“USB”) interface, USB Flash Drives (““UFDs”), MultiMedia Card (“MMC”), Secure Digital (“SD”) cards, miniSD cards, and microSD, and so on. Hence the scope of the claims that follow is not limited by the disclosure herein.

What is claimed is:

1. A storage device that is connectable to a host, the storage device comprising:
a memory device;
an input device operative to receive an input signal from a host of the storage device and from a separate signal source unassociated with the host, regarding selective use or modification of digital contents stored or to be stored in the memory deice, the input device being configured to receive the input signal autonomously, without the input device notifying the host of its activity; and
a controller responsive to an input signal received from the input device for managing storage of one or more digital contents on the storage device, the managing including (i) determining a command from an input signal received from the input device, (ii) determining one or more digital contents to which the command pertains, and (iii) performing an operation on the determined digital contents based on the command.

2. The storage device as in claim 1, wherein at least some of the digital contents are digital photos, and wherein the controller is configured to manage storage of the digital photos by,
determining a picture indicator from the input signal, the picture indicator being derivable from the input signal or a modified version thereof;
selectively associating the picture indicator with one or more of the digital photos; and
storing the one or more digital photos with the associated picture indicator on the storage device.

3. The storage device as in claim 2, wherein the controller embeds the picture indicator within each of the one or more digital photos with which it is associated.

4. The storage device as in claim 2, wherein the picture indicator is one of the digital photos.

5. The storage device as in claim 2, wherein the input signal is a visually coded image representative of a command for the controller.

6. The storage device as in claim 5, further comprising an optical code recognition unit for detecting the visually coded image.

7. The storage device as in claim 2, wherein the controller is operative to update the picture indicator or to use a different picture indicator.

8. The storage device as in claim 2, wherein the controller defines more than one picture indicator and stores the defined picture indicator on the storage device for user selection.

9. The storage device as in claim 2, wherein the controller irreversibly associates the picture indicator with the one or more digital photos.

10. The storage device as in claim 2, wherein the input device includes a voice recognition module operative to receive and process voice.

11. The storage device as in claim 10, wherein the picture indicator is a voice tag associated with the one or more digital photos.

12. The storage device as in claim 10, wherein the input signal is a voice or sound command for the controller to associate the picture indicator with the one or more digital photos.

13. The storage device as in claim 1, wherein the storage device has a configuration complying with flash memory technology.

14. The storage device as in claim 1, wherein the storage device is a memory card.

15. The storage device as in claim 1, wherein the host is any one of a recording device, a mobile phone, and a digital camera.

16. The storage device as in claim 1, wherein the input device includes any one of a host interface, a wireless interface, a mechanical-to-electrical transducer, and an acoustical-to-electrical transducer.

17. The storage device as in claim 16, wherein the mechanical-to-electrical transducer is built into the storage device to facilitate sensing a mechanical pressure that is applied to the host.

18. The storage device as in claim 16, wherein a mechanical input provided to the mechanical-to-electrical transducer and an acoustic input provided to the acoustical-to-electrical transducer are man-made or machine-made.

19. The storage device as in claim 16, wherein an output of the mechanical-to-electrical transducer and an output of the acoustical-to-electrical transducer are or include any one of (i) a command to perform an operation on the one or more digital contents, (ii) first data to be stored in the memory device, and (iii) second data to be associated with or embedded in the one or more digital contents.

20. The storage device as in claim 19, wherein the controller is configured to receive the command, first data or second data formatted as Frequency-Shift Keying (FSK) signals.

21. A method of managing storage of digital contents on a storage device, the method comprising:
by a controller of a storage device connectable to a host,
receiving an input signal from an input device of the storage device regarding selective use or modification of digital contents stored or to be stored in a memory deice of the storage device, the input signal being received from the host or from a signal source unassociated with the host autonomously, without the input device notifying the host of its activity;
in response to the input signal,
determining a command from the input signal;
determining one or more digital contents to which the command pertains; and
performing an operation on the determined digital contents based on the command.

22. The method as in claim 21, wherein performing the operation on the determined digital contents includes,
defining a picture indicator to be the input signal or a modified version thereof;
selectively associating the picture indicator with one or more of the digital contents that are digital photos; and
storing the one or more digital photos with the associated picture indicator on the storage device.

23. The method as in claim 22, wherein the picture indicator is a voice tag.

24. The method as in claim 22, wherein receiving the input signal from the input device includes receiving a voice command for the controller to associate the picture indicator with the one or more digital photos, or to identify the one or more digital photos to be associated with the picture indicator.

25. The method as in claim 22, wherein the picture indicator is one of the digital photos.

26. The method as in claim 25, wherein associating the digital photo with the one or more digital photos includes embedding the digital photo within each of the one or more digital photos.

27. The method as in claim 21, wherein receiving the input signal from the input device includes receiving a coded image representative of an command for the controller to associate the picture indicator with the one or more digital photos.

28. The method as in claim 21, wherein the picture indicator is irreversibly embedded in or associated with the one or more digital photos.

29. The method as in claim 21, wherein receiving the input signal from the input device includes receiving a command, data to be stored in the storage device, or data to be associated with or embedded in the one or more digital contents formatted as Frequency-Shift Keying (FSK) signals.
